(19) United States
(12) Patent Application Publication
(10) Pub. No.: US 2016/0364066 A1
(43) Pub. Date: Dec. 15, 2016

(54) Information Processing Method and Electronic Device

(71) Applicants: Beijing Lenovo Software Ltd., Beijing (CN); Lenovo (Beijing) Co., Ltd., Beijing (CN)

(72) Inventors: Hailong WU, Beijing (CN); Nan LIN, Beijing (CN)

(73) Assignees: BEIJING LENOVO SOFTWARE LTD., Beijing (CN); LENOVO (BEIJING) CO., LTD., Beijing (CN)

(21) Appl. No.: 14/863,845

(22) Filed: Sep. 24, 2015

(30) Foreign Application Priority Data
Jun. 12, 2015 (CN) 201510325236.7

(51) Int. Cl. G06F 3/041; G06F 3/0488

(52) U.S. Cl. CPC G06F 3/0416; G06F 3/04883

(57) ABSTRACT

An information processing method and an electronic device are provided. The method includes: detecting, by the touch unit, a touch operation of a target object; obtaining a touch parameter for the touch operation; determining a touch detection parameter for the touch unit based on the touch parameter; and controlling the touch unit to detect another touch operation of the target object based on the touch detection parameter.

### CROSS REFERENCES OF RELATED APPLICATION

The present application claims the priority to Chinese Patent Application No. 201510325236.7, titled “INFORMATION PROCESSING METHOD AND ELECTRONIC DEVICE”, filed on Jun. 12, 2015 with the State Intellectual Property Office of People's Republic of China, which is incorporated herein by reference in its entirety.

### FIELD OF THE TECHNOLOGY

The present application relates to smart terminal technology in the field of communications, and particularly to an information processing method and an electronic device.

### BACKGROUND

At present, electronic devices, especially electronic devices with a touch screen which may detect a click from a user on the touch screen and respond quickly, have great human-machine interaction capability and are valued by more and more users. However, sensitivity of the touch screen for user operations requires adjustments of the user, and if the detection sensitivity of the touch screen is not adjusted in time, misoperations may be caused, and user experience cannot be improved.

### SUMMARY

In view of this, an information processing method and an electronic device are provided according to the embodiments of the disclosure.

To achieve the objective, the technical solution is implemented as follows.

An information processing method applied to an electronic device with a touch unit includes:

detecting, by the touch unit, a touch operation of a target object;

obtaining a touch parameter for the touch operation;

determining a touch detection parameter for the touch unit based on the touch parameter; and

controlling the touch unit to detect another touch operation of the target object based on the touch detection parameter.

An electronic device includes:

a touch unit, configured to detect a touch operation of a target object; and

a processing unit, configured to obtain a touch parameter for the touch operation; determine a touch detection parameter for the touch unit based on the touch parameter; and control the touch unit to detect another touch operation of the target object based on the touch detection parameter.

In the information processing method and the electronic device provided according to the embodiments of the disclosure, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

### BRIEF DESCRIPTION OF THE DRAWINGS

FIG. 1 is a flow chart of an information processing method according to a first embodiment of the invention;

FIG. 2 is a diagram of a first scene according to an embodiment of the invention;

FIG. 3 is a diagram of a second scene according to an embodiment of the invention;

FIG. 4 is a flow chart of an information processing method according to a second embodiment of the invention;

FIG. 5 is a flow chart of an information processing method according to a third embodiment of the invention;

FIG. 6 is a diagram of a third scene according to an embodiment of the invention; and

FIG. 7 is a composition structure diagram of an electronic device according to an embodiment of the invention.

### DETAILED DESCRIPTION OF THE EMBODIMENTS

The invention is further illustrated in conjunction with drawings and specific embodiments.

### A First Embodiment

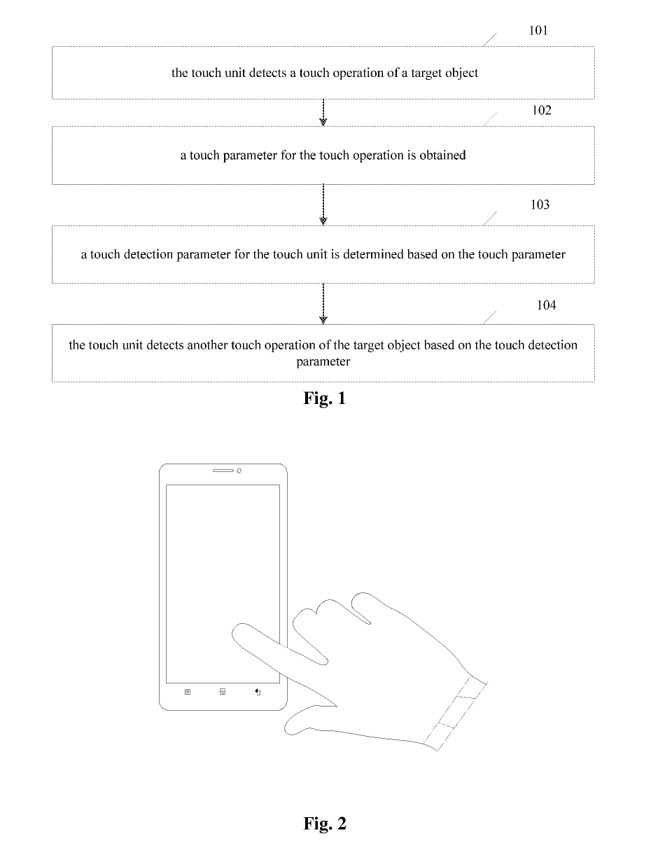

An information processing method applied to an electronic device with a touch unit is provided according to the embodiment of the invention. As shown in FIG. 1, the method includes steps 101-104.

In step 101, the touch unit detects a touch operation of a target object.

In step 102, a touch parameter for the touch operation is obtained.

In step 103, a touch detection parameter for the touch unit is determined based on the touch parameter.

In step 104, the touch unit is controlled to detect the touch operation of the target object based on the touch detection parameter.

The touch unit may be a touch display screen of the electronic device.

The touch operation may be the operation applied on the touch display screen by the target object, and the target object may be a user finger, or a stylus. The operation on the touch display screen may be operation such as click operation, slide operation, or multi-touch operation. A single click operation is taken as an example for subsequent illustration of the embodiment.

The touch parameter in the embodiment may at least include coordinate values of the touch operation, and an electrical parameter value corresponding to the touch operation.

The electrical parameter value corresponding to the touch operation may be a capacitance generated by the touch operation. The capacitance generated by the touch operation may be the coupling capacitance formed between the user finger and a working plane generated due to a human body electric field when the user touches a capacitive screen.

The determining the touch detection parameter for the touch unit based on the touch parameter in step 103, may include determining the touch detection parameter for the touch unit based on the electrical parameter value corresponding to the touch operation among the touch parameters.

It may be seen that, in the solution, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

### A Second Embodiment

An information processing method applied to an electronic device with a touch unit is provided according to the embodiment of the invention. As shown in FIG. 1, the method includes steps 101-104.

In step 101, the touch unit detects a touch operation of a target object.

In step 102, a touch parameter for the touch operation is obtained.

In step 103, a touch detection parameter for the touch unit is determined based on the touch parameter.

In step 104, the touch unit detects the touch operation of the target object based on the touch detection parameter.

The touch unit may be a touch display screen of the electronic device herein.

The touch operation may be the operation applied on the touch display screen by the target object, and the target object may be a user finger, or a stylus. The operation on the touch display screen may be operation such as click operation, slide operation, or multi-touch operation. A single click operation is taken as an example for subsequent illustration of the embodiment.

The touch parameter in the embodiment may at least include coordinate values of the touch operation, and an electrical parameter value corresponding to the touch operation.

The electrical parameter value corresponding to the touch operation may be a capacitance generated through the touch operation. The capacitance generated by the touch operation may be the coupling capacitance formed between the user finger and a working plane due to a human body electric field when the user touches a capacitive screen.

Further, the touch detection parameter in the embodiment may at least include a first touch detection sensitivity and a second touch detection sensitivity; where the first touch detection sensitivity is higher than the second touch detection sensitivity. The first touch detection sensitivity and the second touch detection sensitivity may be thresholds for responding to the capacitance generated by the touch operation. Specifically, the touch detection sensitivity is related to a detection threshold, i.e., in case of high touch detection sensitivity, the threshold of the capacitance for determining effective touch operation is low, and in a case of low touch detection sensitivity, the threshold of the capacitance for determining effective touch operation is high.

According to the embodiment, the determining the touch detection parameter for the touch unit based on the touch parameter, may include: if the touch parameter falls in a first threshold scope, determining the touch unit to perform the detection with the first touch detection sensitivity; if the touch parameter falls in a second threshold scope, determining the touch unit to perform the detection with the second touch detection sensitivity. The first threshold scope and the second threshold scope may be capacitance thresholds preset based on practical conditions, and each value in the first threshold scope is smaller than any value in the second threshold scope.

In addition, the electrical parameter value corresponding to the touch operation may alternatively be a current value generated by the touch operation. The current value generated through the touch operation may be in such a case: when the user touches the capacitive screen, a coupling capacitor is formed between the user finger and the working plane due to the human body electric field, and a high-frequency signal is connected to the working plane, thus the finger absorbs a low current, which flows out from electrodes on four corners of the screen; the currents flowing through the four electrodes are in proportion to distances from the finger to the four corners theoretically, and the location of touch is determined through precise calculation of the proportion of the four currents by a controller. Accordingly, the first touch detection sensitivity and the second touch detection sensitivity may correspond to two threshold scopes based on the current values.

There are two scenes corresponding to the embodiment, in one of which the user performs the touch operation through a glove, i.e., a glove mode, and in the other of which the user performs the touch operation through the finger directly, i.e., a finger mode.

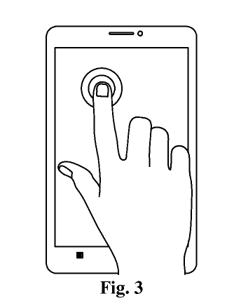

In the glove mode, as shown in FIG. 2, when the user performs the touch operation wearing the glove, there is no direct contact between the finger and the touch unit, thus it requires a higher touch detection sensitivity in the glove mode, i.e., it is required to lower the threshold of the electrical parameter for determining the touch operation as an effective operation; in the glove mode, as shown in FIG. 3, the threshold of the electrical parameter for determining the touch operation as effective operation may be raised, i.e., the touch detection sensitivity may be lowered.

It may be seen that, in the solution, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

### A Third Embodiment

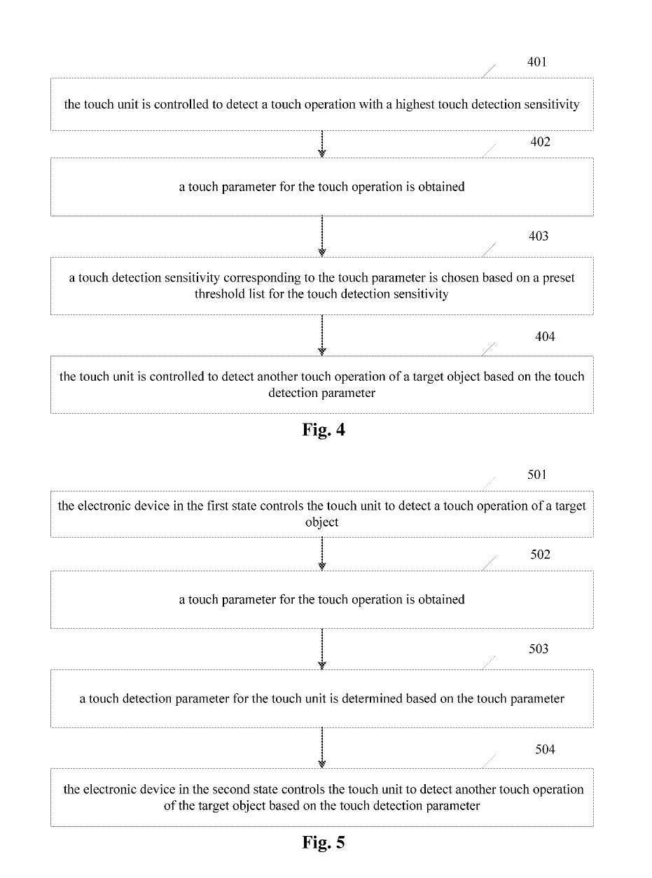

An information processing method applied to an electronic device with a touch unit is provided according to the embodiment of the invention. As shown in FIG. 4, the method includes steps 401-404.

In step 401, the touch unit is controlled to detect a touch operation with a highest touch detection sensitivity.

In step 402, a touch parameter for the touch operation is obtained.

In step 403, a touch detection sensitivity corresponding to the touch parameter is chosen based on a preset threshold list for the touch detection sensitivity.

In step 404, the touch unit is controlled to detect another touch operation of a target object based on the touch detection parameter.

The touch unit may be a touch display screen of the electronic device herein.

The touch operation may be the operation applied on the touch display screen by the target object, and the target object may be a user finger, or a stylus. The operation on the touch display screen may be operation such as click operation, slide operation, or multi-touch operation. A single click operation is taken as an example for subsequent illustration of the embodiment.

The touch parameter in the embodiment may at least include coordinate values of the touch operation, and an electrical parameter value corresponding to the touch operation.

The electrical parameter value corresponding to the touch operation may be a capacitance generated by the touch operation. The capacitance generated by the touch operation may be the coupling capacitance formed between the user finger and a working plane generated due to a human body electric field when the user touches a capacitive screen. Or, the electrical parameter value corresponding to the touch operation may alternatively be a current value generated through the touch operation. The current value generated through the touch operation may be in such a case: when the user touches the capacitive screen, a coupling capacitor is formed between the user finger and the working plane due to the human body electric field, and a high-frequency signal is connected to the working plane, thus the finger absorbs a low current, which flows out from electrodes on four corners of the screen; the currents flowing through the four electrodes are in proportion to distances from the finger to the four corners theoretically, and the location of touch is determined through precise calculation of the proportion of the four currents by a controller. Accordingly, the first touch detection sensitivity and the second touch detection sensitivity may correspond to two threshold scopes based on the current values.

Further, the preset threshold list for the touch detection sensitivity in the embodiment may include thresholds corresponding to two or more touch detection sensitivities. Specifically, the touch detection sensitivity is related to a detection threshold, i.e., in case of high touch detection sensitivity, the threshold of the capacitance for determining effective touch operation is low, and in a case of low touch detection sensitivity, the threshold of the capacitance for determining effective touch operation is high.

It may be seen that, in the solution, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

### A Fourth Embodiment

An information processing method applied to an electronic device with a touch unit is provided according to the embodiment of the invention. The electronic device has a first state and a second state different from the first state; the electronic device can respond to a first part of instructions in an instruction set when in the first state, and can respond to a second part of instructions in the instruction set when in the second state, where a quantity of the first part of instructions is less than a quantity of the second part of instructions. As shown in FIG. 5, the method includes steps 501-504.

In step 501, the electronic device in the first state controls the touch unit to detect a touch operation of a target object.

In step 502, a touch parameter for the touch operation is obtained.

In step 503, a touch detection parameter for the touch unit is determined based on the touch parameter.

In step 504, the electronic device in the second state controls the touch unit to detect another touch operation of the target object based on the touch detection parameter.

The touch unit may be a touch display screen of the electronic device herein.

The touch operation may be the operation applied on the touch display screen by the target object, and the target object may be a user finger, or a stylus. The operation on the touch display screen may be operation such as click operation, slide operation, or multi-touch operation. A single click operation is taken as an example for subsequent illustration of the embodiment.

The touch parameter in the embodiment may at least include coordinate values of the touch operation, and an electrical parameter value corresponding to the touch operation.

The electrical parameter value corresponding to the touch operation may be a capacitance generated through the touch operation. The capacitance generated by the touch operation may be the coupling capacitance formed between the user finger and a working plane due to a human body electric field when the user touches a capacitive screen.

In this embodiment, the first state of the electronic device may be a screen-locked state of the electronic device; and the second state may be an unlocked state of the electronic device. The first part of instructions may only include instructions for responding to the operation on a home key, and instructions for responding to an unlocking operation, etc. The second part of instructions may be instructions for all operations in the electronic device.

Further, the touch detection parameter in the embodiment may at least include a first touch detection sensitivity and a second touch detection sensitivity, where the first touch detection sensitivity is higher than the second touch detection sensitivity. The first touch detection sensitivity and the second touch detection sensitivity may be thresholds for making response to the capacitance generated by the touch operation. Specifically, the touch detection sensitivity is related to a detection threshold, i.e., in case of high touch detection sensitivity, the threshold of the capacitance for determining effective touch operation is low, and in a case of low touch detection sensitivity, the threshold of the capacitance for determining effective touch operation is high.

According to the embodiment, the determining the touch detection parameter for the touch unit based on the touch parameter, may include: if the touch parameter falls in a first threshold scope, determining the touch unit to perform the detection with the first touch detection sensitivity; if the touch parameter falls in a second threshold scope, determining the touch unit to perform the detection with the second touch detection sensitivity. The first threshold scope and the second threshold scope may be capacitance thresholds preset based on practical conditions, and each value in the first threshold scope is smaller than any value in the second threshold scope.

In addition, the electrical parameter value corresponding to the touch operation may alternatively be a current value generated through the touch operation. The current value generated through the touch operation may be in such a case: when the user touches the capacitive screen, a coupling capacitor is formed between the user finger and the working plane due to the human body electric field, and a high-frequency signal is connected to the working plane, thus the finger absorbs a low current, which flows out from electrodes on four corners of the screen; the currents flowing through the four electrodes are in proportion to distances from the finger to the four corners theoretically, and the location of touch is determined through precise calculation of the proportion of the four currents by a controller. Accordingly, the first touch detection sensitivity and the second touch detection sensitivity may correspond to two threshold scopes based on the current values.

There are two scenes corresponding to the embodiment, in one of which the user performs the touch operation through a glove, i.e., a glove mode; and in the other of which the user performs the touch operation through the finger directly, i.e., a finger mode. In the glove mode, as shown in FIG. 2, when the user performs the touch operation wearing the glove, there is no direct contact between the finger and the touch unit, thus it requires a higher touch detection sensitivity in the glove mode, i.e., it is required to lower the threshold of the electrical parameter for determining the touch operation as an effective operation; in the glove mode, as shown in FIG. 3, the threshold of the electrical parameter for determining the touch operation as effective operation may be raised, i.e., the touch detection sensitivity may be lowered.

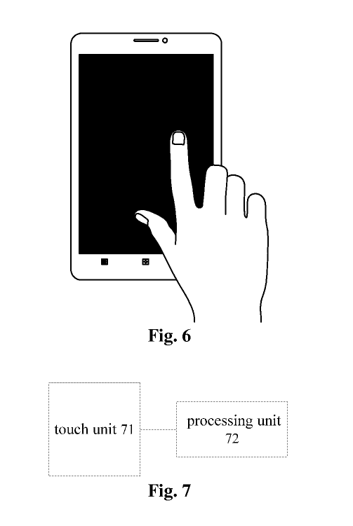

The embodiment is described based on the above two modes. At First, the electronic device is in the screen-locked state, as shown in FIG. 6, i.e., the display screen is currently blacked-out; in the state as shown in FIG. 6, the touch operation from the user is detected, then the electrical parameter value for the touch operation is obtained, it is determined based on the electrical parameter value and a preset threshold that the user performs the operation with the finger, and a subsequent operation detection is performed based on the touch detection sensitivity corresponding to the finger mode.

It may be seen that, in the solution, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

### A Fifth Embodiment

An electronic device is provided according to the embodiment of the invention, as shown in FIG. 7. The device includes a touch unit 71 and a processing unit 72.

The touch unit 71 is configured to detect a touch operation of a target object.

The processing unit 72 is configured to obtain a touch parameter for the touch operation; determine a touch detection parameter for the touch unit based on the touch parameter; and control the touch unit to detect another touch operation of the target object based on the touch detection parameter.

The touch unit may be a touch display screen of the electronic device.

The touch operation may be the operation applied on the touch display screen by the target object, and the target object may be a user finger, or a stylus. The operation on the touch display screen may be operation such as click operation, slide operation, or multi-touch operation. A single click operation is taken as an example for subsequent illustration of the embodiment.

The touch parameter in the embodiment may at least include coordinate values of the touch operation, and an electrical parameter value corresponding to the touch operation.

The electrical parameter value corresponding to the touch operation may be a capacitance generated through the touch operation. The capacitance generated by the touch operation may be the coupling capacitance formed between the user finger and a working plane due to a human body electric field when the user touches a capacitive screen.

Further, the touch detection parameter in the embodiment may at least include a first touch detection sensitivity and a second touch detection sensitivity, where the first touch detection sensitivity is higher than the second touch detection sensitivity. The first touch detection sensitivity and the second touch detection sensitivity may be thresholds for making response to the capacitance generated by the touch operation. Specifically, the touch detection sensitivity is related with a detection threshold, i.e., in case of high touch detection sensitivity, the threshold of the capacitance for determining effective touch operation is low, and in a case of low touch detection sensitivity, the threshold of the capacitance for determining effective touch operation is high.

According to the embodiment, the processing unit is configured to determine the touch unit to perform the detection with the first touch detection sensitivity, if the touch parameter falls in a first threshold scope; and determine the touch unit to perform the detection with the second touch detection sensitivity, if the touch parameter falls in a second threshold scope. The first threshold scope and the second threshold scope may be capacitance thresholds preset based on practical conditions, and each value in the first threshold scope is smaller than any value in the second threshold scope.

In addition, the electrical parameter value corresponding to the touch operation may alternatively be a current value generated through the touch operation. The current value generated through the touch operation may be in such a case: when the user touches the capacitive screen, a coupling capacitor is formed between the user finger and the working plane due to the human body electric field, and a high-frequency signal is connected to the working plane, thus the finger absorbs a low current, which flows out from electrodes on four corners of the screen; the currents flowing through the four electrodes are in proportion to distances from the finger to the four corners theoretically, and the location of touch is determined through precise calculation of the proportion of the four currents by a controller. Accordingly, the first touch detection sensitivity and the second touch detection sensitivity may correspond to two threshold scopes based on the current values.

There are two scenes corresponding to the embodiment, in one of which the user performs the touch operation through a glove, i.e., a glove mode, and in the other of which the user performs the touch operation through the finger directly, i.e., a finger mode.

In the glove mode, as shown in FIG. 2, when the user performs the touch operation wearing the glove, there is no direct contact between the finger and the touch unit, thus it requires a higher touch detection sensitivity in the glove mode, i.e., it is required to lower the threshold of the electrical parameter for determining the touch operation as an effective operation; in the glove mode, as shown in FIG. 3, the threshold of the electrical parameter for determining the touch operation as effective operation may be raised, i.e., the touch detection sensitivity may be lowered.

It may be seen that, in the solution, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

### A Sixth Embodiment

An electronic device is provided according to the embodiment of the invention, as shown in FIG. 7. The device includes a touch unit 71 and a processing unit 72.

The touch unit 71 is configured to detect a touch operation of a target object.

The processing unit 72 is configured to obtain a touch parameter for the touch operation; determine a touch detection parameter for the touch unit based on the touch parameter; and control the touch unit to detect another touch operation of the target object based on the touch detection parameter.

The touch unit may be a touch display screen of the electronic device herein.

The touch unit 71 is further configured to detect the touch operation with a highest touch detection sensitivity; accordingly, the processing unit 72 is further configured to choose a touch detection sensitivity corresponding to the touch parameter based on a preset threshold list for the touch detection sensitivity.

The touch operation may be the operation applied on the touch display screen by the target object, and the target object may be a user finger, or a stylus. The operation on the touch display screen may be operation such as click operation, slide operation, or multi-touch operation. A single click operation is taken as an example for subsequent illustration of the embodiment.

The touch parameter according to the embodiment may at least include coordinate values of the touch operation, and an electrical parameter value corresponding to the touch operation.

The electrical parameter value corresponding to the touch operation may be a capacitance generated by the touch operation. The capacitance generated by the touch operation may be the coupling capacitance formed between the user finger and a working plane due to a human body electric field when the user touches a capacitive screen. Or, the electrical parameter value corresponding to the touch operation may alternatively be a current value generated through the touch operation. The current value generated through the touch operation may be in such a case: when the user touches the capacitive screen, a coupling capacitor is formed between the user finger and the working plane due to the human body electric field, and a high-frequency signal is connected to the working plane, thus the finger absorbs a low current, which flows out from electrodes on four corners of the screen; the currents flowing through the four electrodes are in proportion to distances from the finger to the four corners theoretically, and the location of touch is determined through precise calculation of the proportion of the four currents by a controller. Accordingly, the first touch detection sensitivity and the second touch detection sensitivity may correspond to two threshold scopes based on the current values.

Further, the preset threshold list for the touch detection sensitivity according to the embodiment may include thresholds corresponding to two or more touch detection sensitivities. Specifically, the touch detection sensitivity is related to a detection threshold, i.e., in case of high touch detection sensitivity, the threshold of the capacitance for determining effective touch operation is low, and in a case of low touch detection sensitivity, the threshold of the capacitance for determining effective touch operation is high.

It may be seen that, in the solution, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

### A Seventh Embodiment

An electronic device is provided according to the embodiment of the invention, as shown in FIG. 7. The device includes a touch unit 71 and a processing unit 72.

The touch unit 71 is configured to detect a touch operation of a target object.

The processing unit 72 is configured to obtain a touch parameter for the touch operation; determine a touch detection parameter for the touch unit based on the touch parameter; and control the touch unit to detect another touch operation of the target object based on the touch detection parameter.

The processing unit 72 is further configured to control the electronic device to be in a first state and a second state different from the first state, where the electronic device is able to respond to a first part of instructions in an instruction set when in the first state, and is able to respond to a second part of instructions in the instruction set when in the second state, where a quantity of the first part of instructions is less than the a quantity of the second part of instructions; and is configured to control the touch unit to detect the touch operation of the target object when the electronic device is in the first state; and to control the touch unit to detect the touch operation of the target object based on the touch parameter when the electronic device is in the second state.

The touch unit may be a touch display screen of the electronic device.

The touch operation may be the operation applied on the touch display screen by the target object, and the target object may be a user finger, or a stylus. The operation on the touch display screen may be operation such as click operation, slide operation, or multi-touch operation. A single click operation is taken as an example for subsequent illustration of the embodiment.

The touch parameter in the embodiment may at least include coordinate values of the touch operation, and an electrical parameter value corresponding to the touch operation.

The electrical parameter value corresponding to the touch operation may be a capacitance generated through the touch operation. The capacitance generated by the touch operation may be the coupling capacitance formed between the user finger and a working plane due to a human body electric field when the user touches a capacitive screen.

The first state of the electronic device according to the embodiment may be a screen-locked state of the electronic device; and the second state may be an unlocked state of the electronic device. The first part of instructions may only include instructions for responding to the operation on a home key, and instructions for responding to an unlocking operation, etc. The second part of instructions may be instructions for respective operations in the electronic device.

Further, the touch detection parameter in the embodiment may at least include a first touch detection sensitivity and a second touch detection sensitivity, where the first touch detection sensitivity is higher than the second touch detection sensitivity. The first touch detection sensitivity and the second touch detection sensitivity may be thresholds for making response to the capacitance generated by the touch operation. Specifically, the touch detection sensitivity is related to a detection threshold, i.e., in case of high touch detection sensitivity, the threshold of the capacitance for determining effective touch operation is low, and in a case of low touch detection sensitivity, the threshold of the capacitance for determining effective touch operation is high.

According to the embodiment, the processing unit 72 is configured to determine the touch unit to perform the detection with the first touch detection sensitivity if the touch parameter falls in a first threshold scope; and determine the touch unit to perform the detection with the second touch detection sensitivity if the touch parameter falls in a second threshold scope. The first threshold scope and the second threshold scope may be capacitance thresholds preset based on practical conditions, and each value in the first threshold scope is smaller than any value in the second threshold scope.

In addition, the electrical parameter value corresponding to the touch operation may alternatively be a current value generated through the touch operation. The current value generated through the touch operation may be in such a case: when the user touches the capacitive screen, a coupling capacitor is formed between the user finger and the working plane due to the human body electric field, and a high-frequency signal is connected to the working plane, thus the finger absorbs a low current, which flows out from electrodes on four corners of the screen; the currents flowing through the four electrodes are in proportion to distances from the finger to the four corners theoretically, and the location of touch is determined through precise calculation of the proportion of the four currents by a controller. Accordingly, the first touch detection sensitivity and the second touch detection sensitivity may correspond to two threshold scopes based on the current values.

There are two scenes corresponding to the embodiment, in one of which the user performs the touch operation through a glove, i.e., a glove mode; and in the other of which the user performs the touch operation through the finger directly, i.e., a finger mode. In the glove mode, as shown in FIG. 2, when the user performs the touch operation wearing the glove, there is no direct contact between the finger and the touch unit, thus it requires a higher touch detection sensitivity in the glove mode, i.e., it is required to lower the threshold of the electrical parameter for determining the touch operation as an effective operation; in the glove mode, as shown in FIG. 3, the threshold of the electrical parameter for determining the touch operation as effective operation may be raised, i.e., the touch detection sensitivity may be lowered.

The embodiment is described based on the above two modes. At First, the electronic device is in the screen-locked state, as shown in FIG. 6, i.e., the display screen is currently blacked-out; in the state as shown in FIG. 6, the touch operation from the user is detected, then the electrical parameter value for the touch operation is obtained, it is determined based on the electrical parameter value and a preset threshold that the user performs the operation with the finger, and a subsequent operation detection is performed based on the touch detection sensitivity corresponding to the finger mode.

It may be seen that, in the solution, the touch parameter is obtained through the touch unit, and the touch detection parameter for the touch unit is determined based on the touch parameter, so that the touch unit detects the touch operation based on the touch detection parameter. Hence, the detection parameter of the touch unit may be adjusted quickly based on the touch operation, and user experience is enhanced.

It should be understood that, according to the embodiments of the disclosure, the disclosed system, apparatus and methods may be implemented in other ways. For example, the described apparatus embodiment is merely exemplary. The division of the units is merely based on logical functions, and the units may be divided with other approaches in practice. For example, multiple units or modules may be combined, or may be integrated into another system, or some features may be omitted or not be implemented. In addition, the displayed or discussed couplings, direct couplings or communication connections between individual components may be implemented via indirect couplings or communication connections between some interfaces, devices or units, which may be electrical, mechanical or in other forms.

The units described as separate components may be or not be separated physically. The components shown as units may either be or not be physical units, i.e., the units may be located at one place or may be distributed onto multiple network units. All of or part of the units may be selected based on actual needs to implement the solutions according to the embodiments of the disclosure.

In addition, individual function units according to the embodiments of the disclosure may be integrated in one processing unit, or the units may exist separately, or two or more units may be integrated in one unit.

Those skilled in the art may understand that, all of or a part of the steps implementing the above method may be accomplished through related hardware instructed by programs, and the programs may be stored in a computer readable storage medium. When executing the programs, the steps of method embodiments are executed; the forgoing storage medium includes various mediums storing programs such as mobile storage device, read only memory (ROM, Read-Only Memory), random access memory (RAM, Random Access Memory), disk and compact disc.

The described is merely specific implementation of the disclosure, and the scope of protection of the disclosure is not limited hereto. Any change or replacement by those skilled in the art without departing from the technical scope of the disclosure should fall in the scope of protection of the disclosure. Thus, the scope of protection of the disclosure is subject to the scope of protection of the claims.

1. An information processing method, applied to an electronic device with a touch unit, the method comprising:
detecting, by the touch unit, a touch operation of a target object;
obtaining a touch parameter for the touch operation;
determining a touch detection parameter for the touch unit based on the touch parameter; and
controlling the touch unit to detect another touch operation of the target object based on the touch detection parameter.

2. The method according to claim 1, wherein the touch detection parameter at least comprises a first touch detection sensitivity and a second touch detection sensitivity; the first touch detection sensitivity is higher than the second touch detection sensitivity.

3. The method according to claim 2, wherein determining the touch detection parameter for the touch unit based on the touch parameter, comprises:
if the touch parameter falls in a first threshold scope, determining the touch unit to perform the detection with the first touch detection sensitivity; and
if the touch parameter falls in a second threshold scope, determining the touch unit to perform the detection with the second touch detection sensitivity.

4. The method according to claim 1, wherein detecting, by the touch unit, the touch operation of the target object, comprises: controlling the touch unit to detect the touch operation with a highest touch detection sensitivity; and
determining the touch detection parameter for the touch unit based on the touch parameter accordingly comprises:
choosing a touch detection sensitivity corresponding to the touch parameter based on a preset threshold list for the touch detection sensitivity.

5. The method according to claim 1, wherein:
the electronic device has a first state and a second state different from the first state; the electronic device is able to respond to a first part of instructions in an instruction set when in the first state, and is able to respond to a second part of instructions in the instruction set when in the second state, and a quantity of the first part of instructions is less than the a quantity of the second part of instructions; and
detecting, by the touch unit, the touch operation of the target object, comprises:
controlling the touch unit to detect the touch operation of the target object when the electronic device is in the first state; and
controlling the touch unit to detect another touch operation of the target object based on the touch detection parameter comprises:
controlling the touch unit to detect another touch operation of the target object based on the touch detection parameter when the electronic device is in the second state.

6. An electronic device comprising:
a touch unit, configured to detect a touch operation of a target object; and
a processing unit, configured to obtain a touch parameter for the touch operation; determine a touch detection parameter for the touch unit based on the touch parameter; and control the touch unit to detect another touch operation of the target object based on the touch detection parameter.

7. The electronic device according to claim 6, wherein the touch detection parameter at least comprises a first touch detection sensitivity and a second touch detection sensitivity; the first touch detection sensitivity is higher than the second touch detection sensitivity.

8. The electronic device according to claim 7, wherein the processing unit is further configured to determine the touch unit to perform the detection with the first touch detection sensitivity if the touch parameter falls in a first threshold scope; and determine the touch unit to perform the detection with the second touch detection sensitivity if the touch parameter falls in a second threshold scope.

9. The electronic device according to claim 6, wherein
the touch unit is further configured to detect the touch operation with a highest touch detection sensitivity; and
accordingly the processing unit is configured to choose a touch detection sensitivity corresponding to the touch parameter based on a preset threshold list for the touch detection sensitivity.

10. The electronic device according to claim 6, wherein the processing unit is further configured to control the electronic device to be in a first state and a second state different from the first state, wherein the electronic device is able to respond to a first part of instructions in an instruction set when in the first state, and is able to respond to a second part of instructions in the instruction set when in the second state, a quantity of the first part of instructions is less than the a quantity of the second part of instructions; configured to control the touch unit to detect the touch operation of the target object when the electronic device is in the first state; and configured to control the touch unit to detect the touch operation of the target object based on the touch parameter when the electronic device is in the second state.
